(19) United States
(12) Patent Application Publication
(10) Pub. No.: US 2011/0103040 A1
(43) Pub. Date: May 5, 2011

(54) ILLUMINATING DEVICE AND DISPLAY DEVICE

(75) Inventor: Daisuke Teragawa, Osaka-shi (JP)

(73) Assignee: SHARP KABUSHIKI KAISHA, Osaka-shi, Osaka (JP)

(21) Appl. No.: 12/991,945

(22) PCT Filed: Jan. 9, 2009
(86) PCT No.: PCT/JP2009/050242

§ 371 Date: Nov. 10, 2010

(30) Foreign Application Priority Data
May 29, 2008 (JP) 2008-141158 2008

(51) Int. Cl. F21V 11/00; G09F 13/04

(52) U.S. Cl. 362/97.1; 362/223

(57) ABSTRACT

In an illuminating device (3) provided with a cold cathode fluorescent tube (linear light source) (20), a chassis (12) that houses the cold cathode fluorescent tube (20), a diffusion plate (15) that diffuses light from the cold cathode fluorescent tube (20), and a diffusion plate supporter (21) that is provided in the chassis (12) to support the diffusion plate (15), the diffusion plate supporter (21) includes: a substrate (21a) that is configured to be capable of being deformed elastically in response to changes in ambient temperature; an attachment portion (21c) that is provided on one (21a1) of opposed surface sides of the substrate (21a) and attaches the substrate (21a) to the chassis (12); and a support portion (21b) that is located on the other (21a2) of the opposed surface sides of the substrate (21a) so as to come into contact with the diffusion plate (15).

### TECHNICAL FIELD

The present invention relates to an illuminating device for use as a backlight or the like and a display device using the same.

### BACKGROUND ART

In recent years, for example, a liquid crystal display device has been used widely in liquid crystal televisions, monitors, mobile phones, and the like as a flat panel display having features such as a smaller thickness and a lighter weight than a conventional cathode ray tube. Such a liquid crystal display device includes an illuminating device that emits light, and a liquid crystal panel that displays a desired image by serving as a shutter with respect to light from a light source provided in the illuminating device.

Further, the above-described illuminating device is classified roughly into a direct type and an edge-light type depending on the arrangement of the light source with respect to the liquid crystal panel. A liquid crystal display device provided with a liquid crystal panel of 20 inches or more generally uses the direct type illuminating device that can achieve an increase in brightness and size more easily than the edge-light type illuminating device. More specifically, in the direct type illuminating device, a plurality of linear light sources are arranged on the rear side (non-display surface) of the liquid crystal panel. Since the linear light sources can be arranged right on the reverse side of the liquid crystal panel, it is possible to use a number of the linear light sources. Thus, the direct type illuminating device can achieve high brightness easily and is suitable for an increase in brightness and size. Further, the direct type illuminating device has a hollow structure and hence is light-weight even when enlarged. This also allows the direct type illuminating device to be suitable for an increase in brightness and size.

Further, in the direct type illuminating device as described above, a diffusion plate usually is located above a cold cathode fluorescent tube as the linear light source, thereby preventing a shadow (lamp image) of the cold cathode fluorescent tube from appearing on an emission surface that is disposed so as to be opposed to the liquid crystal panel and allowing plane-shaped light that is output from the emission surface to illuminate the liquid crystal panel to have a uniform brightness.

Further, it has been proposed, as described in JP 2007-157451A, for example, that in order to prevent a diffusion plate made of a synthetic resin or the like from being bent under its own weight, the conventional illuminating device uses a diffusion plate support member to support the diffusion plate.

### DISCLOSURE OF INVENTION

### Problem to be Solved by the Invention

However, in the conventional illuminating device as described above, noise may be generated and leak out when the diffusion plate expands/contracts.

Specifically, in the conventional illuminating device, the diffusion plate is placed on a one-end opening side of a metal chassis that houses the cold cathode fluorescent tube so as to be capable of expanding/contracting. Meanwhile, in the conventional illuminating device, the diffusion plate support member (diffusion plate supporter) is fixed to the chassis with its front end being in contact with the diffusion plate. Thus, in the conventional illuminating device, when the diffusion plate expands/contracts in response to changes in ambient temperature, a friction sound is generated between the diffusion plate and the diffusion plate support member, which then may be transmitted to the outside as noise.

In view of the above-described problem, it is an object of the present invention to provide an illuminating device that can prevent the generation of noise even when a diffusion plate expands/contracts, and a display device using the same.

### Means for Solving Problem

In order to achieve the above-described object, an illuminating device according to the present invention is provided with a linear light source, a chassis that houses the linear light source, and a diffusion plate that diffuses light from the linear light source. The illuminating device includes a diffusion plate supporter that is provided in the chassis to support the diffusion plate. The diffusion plate supporter includes: a substrate that is configured to be capable of being deformed elastically in response to changes in ambient temperature; an attachment portion that is provided on one of opposed surface sides of the substrate and attaches the substrate to the chassis; and a support portion that is located on the other of the opposed surface sides of the substrate so as to come into contact with the diffusion plate.

In the illuminating device configured as described above, the diffusion plate supporter is attached to the chassis via the attachment portion and includes the substrate that is configured to be capable of being deformed elastically in response to changes in ambient temperature. Further, the support portion that comes into contact with the diffusion plate is provided on the substrate. Thus, when the diffusion plate expands/contracts, the substrate is deformed elastically along with the diffusion plate, thereby minimizing a change in the relative positional relationship between the diffusion plate and the support portion. Consequently, even when the diffusion plate expands/contracts, it is possible to prevent a friction sound from being generated between the diffusion plate and the support portion and hence to prevent the generation of noise, unlike the above-described conventional example.

Further, in the above-described illuminating device, the substrate preferably is made of a material having substantially the same coefficient of thermal expansion as the diffusion plate.

In this case, the substrate is deformed elastically in response to changes in ambient temperature to substantially the same degree as the expansion/contraction of the diffusion plate, thereby preventing the generation of noise reliably.

It should be noted that substantially the same coefficient of thermal expansion as used herein refers to a value in a range of about 6 to 10×10⁻⁵ (/° C.).

Further, in the above-described illuminating device, the substrate may be attached to the chassis along a longitudinal direction of the linear light source, and the two attachment portions may be located on the substrate along the longitudinal direction.

In this case, the substrate can be prevented from being rotated with respect to the chassis even when it is deformed elastically in response to changes in ambient temperature.

Further, in the above-described illuminating device, the substrate preferably is attached to the chassis along a longitudinal direction of the linear light source, and the two or more support portions preferably are located on the substrate along the longitudinal direction.

In this case, since a number of the support portions are located on the single substrate, it is possible to provide easily the illuminating device that only requires a small number of components and can be assembled easily.

Further, in the above-described illuminating device, the substrate preferably is attached to the chassis along a longitudinal direction of the linear light source, and the attachment portion and the support portion preferably are located on the substrate at positions different from each other in the longitudinal direction.

In this case, the support portion is located in place so that the elastic deformation of the substrate is likely to occur, thereby preventing the generation of a friction sound between the support portion and the diffusion plate more reliably.

Further, in the above-described illuminating device, a plurality of the diffusion plate supporters may be provided in the chassis along a longitudinal direction of the linear light source. Among a plurality of the diffusion plate supporters, the diffusion plate supporter provided on one end side in the longitudinal direction may include the attachment portion on the other end side of the substrate in the longitudinal direction, while the diffusion plate supporter provided on the other end side in the longitudinal direction may include the attachment portion on one end side of the substrate in the longitudinal direction.

In this case, each of the diffusion plate supporters among a plurality of the diffusion plate supporters that is provided on the one end side or the other end side in the longitudinal direction is located in the chassis so that the elastic deformation of the substrate is likely to occur, thereby preventing the generation of noise more reliably in each of the diffusion plate supporters.

Further, in the above-described illuminating device, a holder that holds the linear light source may be located on the substrate.

In this case, it is possible to omit a holding member for holding the linear light source, resulting in a reduced number of components of the illuminating device.

Further, in the above-described illuminating device, the holder preferably is located in the vicinity of the attachment portion on the substrate.

In this case, the holder is located in place so that the elastic deformation of the substrate is less likely to be inhibited, thereby preventing the generation of noise more reliably even when the holder is located on the substrate.

Further, in the above-described illuminating device, a slide contact portion that slides to contact a surface on the chassis side preferably is provided on one of the surface sides of the substrate on an end side of the substrate.

In this case, the slide contact portion allows the substrate to slide easily on the surface on the chassis side, thereby facilitating the elastic deformation of the substrate.

Further, a display device of the present invention uses any of the above-described illuminating devices.

The display device configured as described above uses the illuminating device that can prevent the generation of noise even when the diffusion plate expands/contracts. Thus, it is possible to provide easily the low-noise display device in which the generation of noise is prevented.

### EFFECTS OF THE INVENTION

According to the present invention, it is possible to provide an illuminating device that can prevent the generation of noise even when a diffusion plate expands/contracts, and a display device using the same.

### BRIEF DESCRIPTION OF DRAWINGS

FIG. 1 is a schematic cross-sectional view illustrating an illuminating device and a liquid crystal display device according to a first embodiment of the present invention.

FIG. 2 is a plan view illustrating a configuration of main portions of the illuminating device shown in FIG. 1.

FIG. 3 is a cross-sectional view taken along a line III-III shown in FIG. 2.

FIGS. 4A and 4B are views illustrating a specific configuration of a diffusion plate supporter shown in FIG. 1. FIG. 4A is a plan view of the diffusion plate supporter when viewed from an arrow A side in FIG. 3, and FIG. 4B is a view illustrating a specific configuration of a slide contact portion shown in FIG. 4A.

FIG. 5 is a plan view illustrating a configuration of main portions of an illuminating device according to a second embodiment of the present invention.

FIG. 6 is a cross-sectional view taken along a line VI-VI shown in FIG. 5.

FIG. 7 is a schematic cross-sectional view illustrating an illuminating device and a liquid crystal display device according to a third embodiment of the present invention.

FIG. 8 is a plan view illustrating a configuration of main portions of the illuminating device shown in FIG. 7.

FIG. 9 is a cross-sectional view taken along a line IX-IX shown in FIG. 8.

FIG. 10 is a view illustrating a specific configuration of a diffusion plate supporter shown in FIG. 7 when viewed from an arrow A side in FIG. 9.

### DESCRIPTION OF THE INVENTION

Hereinafter, preferred embodiments of an illuminating device and a display device using the same according to the present invention will be described with reference to the drawings. It should be noted that the following description is directed to the case where the present invention is applied to a transmission type liquid crystal display device by way of example. Further, the size and size ratio of the constituent members in each figure do not exactly reflect those of actual constituent members.

### First Embodiment

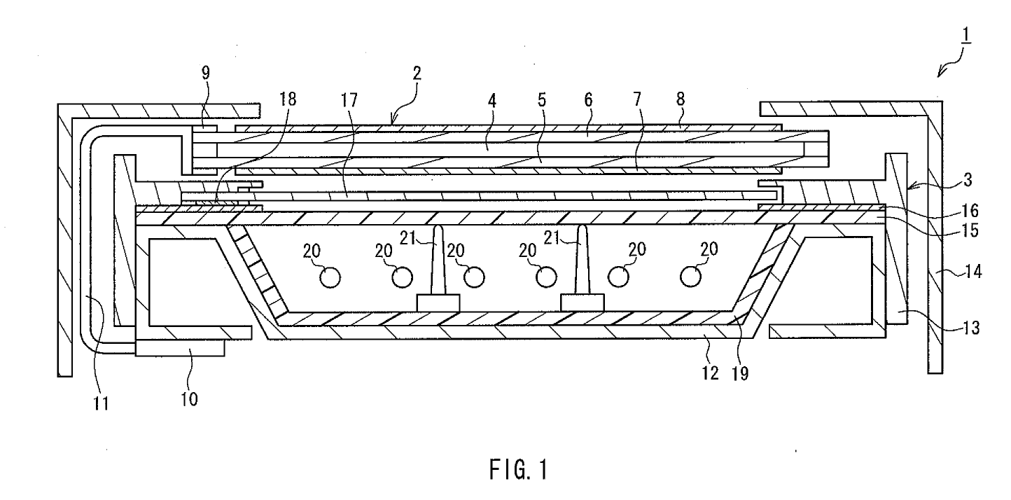

FIG. 1 is a schematic cross-sectional view illustrating an illuminating device and a liquid crystal display device according to a first embodiment of the present invention. In FIG. 1, a liquid crystal display device 1 of the present embodiment includes a liquid crystal panel 2 as a display portion that is located with the upper side in the figure defined as a viewing side (display surface side), and an illuminating device 3 of the present invention that is arranged on the non-display surface side of the liquid crystal panel 2 (lower side in the figure) and generates illumination light to illuminate the liquid crystal panel 2.

The liquid crystal panel 2 includes a liquid crystal layer 4, a pair of transparent substrates 5 and 6 between which the liquid crystal layer 4 is sandwiched, and polarizing plates 7 and 8 provided respectively on outer surfaces of the transparent substrates 5 and 6. Further, the liquid crystal panel 2 includes a driver 9 for driving the liquid crystal panel 2, and a driving circuit 10 connected to the driver 9 via a flexible printed board 11, so that the liquid crystal layer 4 can be driven on a pixel basis. In the liquid crystal panel 2, the polarization state of the illumination light incident through the polarizing plate 7 is modulated by the liquid crystal layer 4, and the amount of light passing through the polarizing plate 8 is controlled, whereby a desired image is displayed.

The illuminating device 3 includes a bottomed chassis 12 with the upper side in the figure (liquid crystal panel 2 side) opened, and a frame 13 located on the liquid crystal panel 2 side of the chassis 12. Further, the chassis 12 and the frame 13 are made of a metal and are sandwiched by a bezel 14 having an L-shaped cross section with the liquid crystal panel 2 located above the frame 13. Thus, the illuminating device 3 is assembled with the liquid crystal panel 2, so that they are integrated into the liquid crystal display device 1.

Further, the illuminating device 3 includes a diffusion plate 15 located so as to cover the opening of the chassis 12, an optical sheet 17 located above the diffusion plate 15 on the liquid crystal penal 2 side, and a reflecting sheet 19 provided on an inner surface of the chassis 12. In the illuminating device 3, a plurality of (for example, six) cold cathode fluorescent tubes 20 as linear light sources are provided at predetermined intervals in the horizontal direction in FIG. 1.

The diffusion plate 15, which is made of, for example, a rectangular-shaped synthetic resin having a thickness of about 2 mm, diffuses light (containing light reflected from the reflecting sheet 19) from the cold cathode fluorescent tubes 20 and outputs the light to the optical sheet 17 side. Further, four sides of the diffusion plate 15 are placed on a frame-shaped surface of the chassis 12 provided on the upper side thereof, and the diffusion plate 15 is incorporated in the illuminating device 3 while being sandwiched between the frame-shaped surface of the chassis 12 and an inner surface of the frame 13 with a pressure member 16 capable of being deformed elastically interposed therebetween. Further, the diffusion plate 15 is supported by a diffusion plate supporter 21 of the present embodiment, whereby the diffusion plate 15 is prevented from being bent toward the inside of the chassis 12 as a housing that houses the cold cathode fluorescent tubes 20.

Further, the diffusion plate 15 is held so as to be movable between the chassis 12 and the pressure member 16. Even when the diffusion plate 15 expands/contracts due to the influence of heat caused by heat generation in the cold cathode fluorescent tubes 20, temperature rise inside the chassis 12, and the like, the expansion/contraction is absorbed by the elastic deformation of the pressure member 16, whereby a decrease in the diffusion of the light from the cold cathode fluorescent tubes 20 is minimized.

The optical sheet 17 includes a focusing sheet and a diffusion sheet formed of, for example, a synthetic resin film having a thickness of about 0.1 to 0.5 mm and is configured to increase the brightness of the illumination light to the liquid crystal panel 2 and to enhance the display quality on the display surface of the liquid crystal panel 2. Further, on the optical sheet 17, known optical sheet materials such as a prism sheet and a polarizing sheet for, for example, enhancing the display performance, e.g., improving a viewing angle, on the display surface of the liquid crystal panel 2 are laminated suitably, if required. The optical sheet 17 is configured to convert the light output from the diffusion plate 15 into plane-shaped light having a predetermined brightness (for example, 10000 cd/m²) or more and having a uniform brightness and to allow the converted light to be output to the liquid crystal panel 2 side as the illumination light.

Further, the optical sheet 17 is provided with a protrusion protruding to the left side in the figure at the center on the left end side in FIG. 1, which is to be the upper side during actual use of the liquid crystal display device 1, for example. In the optical sheet 17, only the protrusion is sandwiched between the inner surface of the frame 13 and the pressure member 16 with an elastic material 18 interposed therebetween, and the optical sheet 17 is incorporated in the illuminating device 3 so as to be capable of expanding/contracting. Thus, the optical sheet 17 is configured in such a manner that, even when the expansion/contraction (plastic) deformation occurs due to the influence of heat caused by heat generation in the cold cathode fluorescent tubes 20 and the like, the optical sheet 17 is capable of expanding/contracting freely with respect to the protrusion, whereby wrinkles, warpage, and the like are minimized in the optical sheet 17. Consequently, in the liquid crystal display device 1, it is possible to minimize degradation in display quality, such as non-uniform brightness, on the display surface of the liquid crystal panel 2 due to warpage and the like of the optical sheet 17.

The reflecting sheet 19, which is formed of, for example, a synthetic resin film having a thickness of about 0.1 to 2.0 mm, functions as a reflector that reflects the light from the cold cathode fluorescent tubes 20 towards the diffusion plate 15. The surface of the reflecting sheet 19 on the cold cathode fluorescent tubes 20 side is coated, for example, in a white color, whereby the light emitted from the cold cathode fluorescent tubes 20 is reflected efficiently to the diffusion plate 15 side, resulting in an increase in the light utilization efficiency and the brightness in the diffusion plate 15. Besides the above description, the reflecting sheet 19 may be formed of a thin metal film of aluminum, silver, or the like having a high light reflectance.

Each of the cold cathode fluorescent tubes 20 is of a straight-tube fluorescent lamp type, and electrode portions (not shown) provided at both ends thereof are supported outside the chassis 12. Also, each of the cold cathode fluorescent tubes 20 is configured to have a small diameter of about 3.0 to 4.0 mm so as to have excellent light-emission efficiency. The cold cathode fluorescent tubes 20 are held inside the chassis 12 while being kept at predetermined distances from the diffusion plate 15 and the reflecting sheet 19 by a light source holding member not shown. Further, the cold cathode fluorescent tubes 20 are arranged so that the longitudinal direction thereof is parallel to a direction perpendicular to the direction of gravity. This arrangement prevents mercury (vapor) sealed inside each of the cold cathode fluorescent tubes 20 from being concentrated on one end side in the longitudinal direction due to the action of gravity, resulting in significantly improved lamp life.

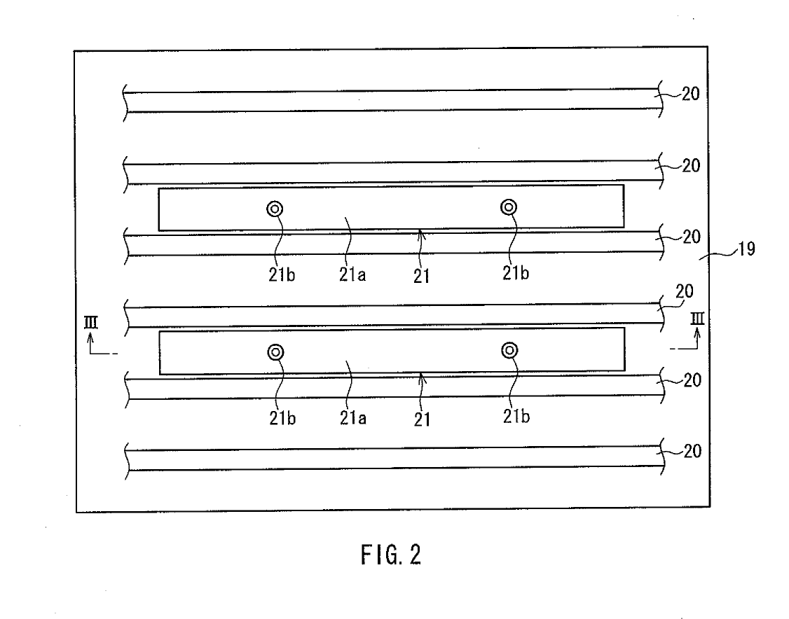

Here, the diffusion plate supporter 21 of the present embodiment will be described specifically also with reference to FIGS. 2 to 4.

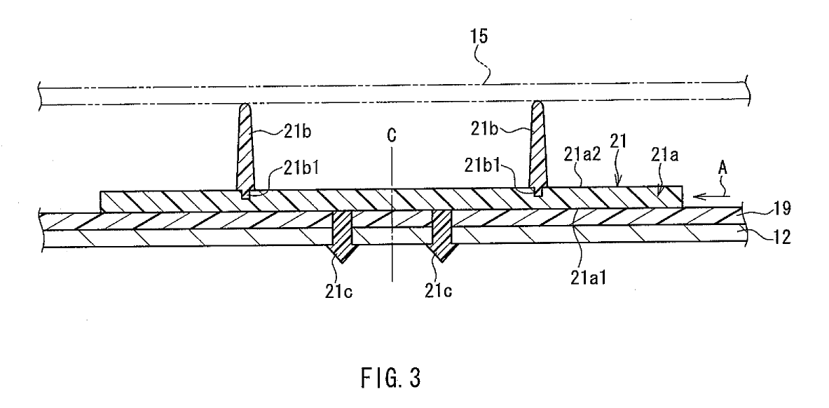

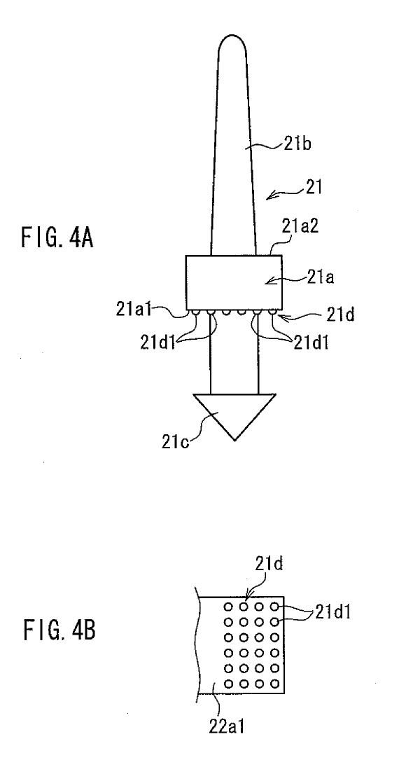

FIG. 2 is a plan view illustrating a configuration of main portions of the illuminating device shown in FIG. 1. FIG. 3 is a cross-sectional view taken along a line III-III shown in FIG. 2. FIGS. 4A and 4B are views illustrating a specific configuration of the diffusion plate supporter shown in FIG. 1. FIG. 4A is a plan view of the diffusion plate supporter when viewed from an arrow A side in FIG. 3, and FIG. 4B is a view illustrating a specific configuration of a slide contact portion shown in FIG. 4A.

As shown in FIG. 2 by way of example, the two diffusion plate supporters 21 are located inside the chassis 12 in the present embodiment. Each of the diffusion plate supporters 21 is provided between the two adjacent cold cathode fluorescent tubes 20 along the longitudinal direction of the cold cathode fluorescent tubes 20 (horizontal direction in FIG. 2).

Further, as shown in FIG. 3, each of the diffusion plate supporters 21 includes a flat substrate 21a provided in the chassis 12 so as to be in contact with the surface of the reflecting sheet 19, and two attachment portions 21c and two support portions 21b located respectively on a lower surface 21a1 and an upper surface 21a2 of the substrate 21a opposed to each other.

The substrate 21a is made of a material that is elastically deformable in response to changes in ambient temperature, and is attached to the chassis 12 along the longitudinal direction of the cold cathode fluorescent tubes 20. Further, the substrate 21a is made of a material having substantially the same coefficient of thermal expansion as the diffusion plate 15. Specifically, the substrate 21a is made of a transparent synthetic resin such as a PC (polycarbonate) resin, a PS (polystyrene) resin, an MS (methyl methacrylate-styrene copolymer) resin, an ABS (acrylonitrile-butadiene-styrene copolymer) resin, and an acrylic resin such as an MMA (methacrylate resin), so that the substrate 21a is elastically deformable in response to changes in internal temperature (ambient temperature) of the chassis 12. In other words, the substrate 21a is configured to be capable of expanding and contracting due to thermal contraction in response to changes in ambient temperature.

Each of the support portions 21b has an approximately conical shape and supports the diffusion plate 15 substantially by being in contact with a surface of the diffusion plate 15. As shown in FIG. 3, a front end portion of the support portion 21b is formed to have an arc-shaped cross section, thereby supporting the diffusion plate 15 without damaging the surface of the diffusion plate 15. The support portion 21b is made of the same synthetic resin as that used for the substrate 21a. Further, the support portion 21b is configured to be attachable/detachable with respect to the substrate 21a on the upper surface 21a2 side as the other surface of the substrate 21a. More specifically, the support portion 21b includes a protrusion 21b1 at its lower end, which is engaged in a hole formed on the upper surface 21a2 of the substrate 21a, whereby the support portion 21b is attached to the substrate 21a.

Each of the attachment portions 21c has an approximately cylindrical shape and is inserted into a through hole provided in the reflecting sheet 19 and the chassis 12. As shown in FIG. 3, a front end portion of the attachment portion 21c has a triangular cross section, and protrudes to the outside of the chassis 12 and is locked on an outer surface of the chassis 12, whereby the diffusion plate supporter 21 is assembled with the illuminating device 3. The attachment portion 21c is made the same synthetic resin as that used for the substrate 21a. Further, the attachment portion 21c is configured to be attachable/detachable with respect to the substrate 21a on the lower surface 21a1 side as one surface of the substrate 21a.

In the diffusion plate supporter 21, the two support portions 21b are located on the substrate 21a so as to be symmetrical with respect to a center position (shown by “C” in FIG. 3) in the longitudinal direction. Similarly, the two attachment portions 21c are located on the substrate 21a so as to be symmetrical with respect the center position in the longitudinal direction. Further, as shown in FIG. 3, in the diffusion plate supporter 21, the support portions 21b and the attachment portions 21c are located on the substrate 21a at positions different from each other in the longitudinal direction. Specifically, the two support portions 21b are attached to the substrate 21a on outer sides in the longitudinal direction relative to the attachment portions 21c.

Besides the above description, surfaces of the substrate 21a and the support portions 21b may be colored in a color having a high light reflectance, such as white, milk white, and silver. In such a case, it is possible to increase the amount of light emitted from the cold cathode fluorescent tubes 20 to the diffusion plate 15 side easily. Further, the support portions 21b and the attachment portion 21c may be made of a material different from that of the substrate 21a.

Further, as shown in FIGS. 4A and 4B, in the diffusion plate supporter 21, a slide contact portion 21d that slides to contact the surface of the reflecting sheet 19 on the chassis 12 side is provided on the lower surface (one surface) 21a1 side of the substrate 21a on end sides of the substrate 21a (both end sides in the longitudinal direction). The slide contact portion 21d is composed of, for example, a plurality of semicircular protruding portions 21d1, so that the substrate 21a easily slides on the surface (surface on the chassis 12 side) of the reflecting sheet 19. More specifically, when the substrate 21a is deformed elastically in response to changes in ambient temperature, the slide contact portion 21d slides on the surface of the reflecting sheet 19 so as to facilitate the elastic deformation of the substrate 21a (the same applies to the embodiments to be described later).

In the illuminating device 3 of the present embodiment configured as described above, each of the diffusion plate supporters 21 is attached to the chassis 12 via the attachment portions 21c and includes the substrate 21a that is configured to be capable of being deformed elastically in response to changes in ambient temperature. Further, the support portions 21b that come into contact with the diffusion plate 15 to support the same substantially are provided on the substrate 21a. Thus, in the illuminating device 3 of the present embodiment, when the diffusion plate 15 expands/contracts, the substrate 21a is deformed elastically along with the diffusion plate 15, thereby minimizing a change in the relative positional relationship between the diffusion plate 15 and the support portions 21b. Consequently, in the illuminating device 3 of the present embodiment, even when the diffusion plate 15 expands/contracts, it is possible to prevent a friction sound from being generated between the diffusion plate 15 and the support portions 21b and hence to prevent the generation of noise, unlike the above-described conventional example.

Further, in the illuminating device 3 of the present embodiment, the substrate 21a is made of a material having substantially the same coefficient of thermal expansion as the diffusion plate 15. Thus, the substrate 21a can be deformed elastically in response to changes in ambient temperature to substantially the same degree as the expansion/contraction of the diffusion plate 15, thereby preventing the generation of noise reliably.

Further, in the illuminating device 3 of the present embodiment, the two support portions 21b are located on the substrate 21a on outer sides in the longitudinal direction relative to the attachment portions 21c. Thus, the support portions 21b are located in place so that the elastic deformation of the substrate 21a is likely to occur, thereby preventing the generation of a friction sound between the support portions 21b and the diffusion plate 15 more reliably.

Further, the liquid crystal display device 1 of the present embodiment uses the illuminating device 3 that can prevent the generation of noise even when the diffusion plate 15 expands/contracts. Thus, it is possible to provide easily the low-noise liquid crystal display device 1 in which the generation of noise is prevented.

### Second Embodiment

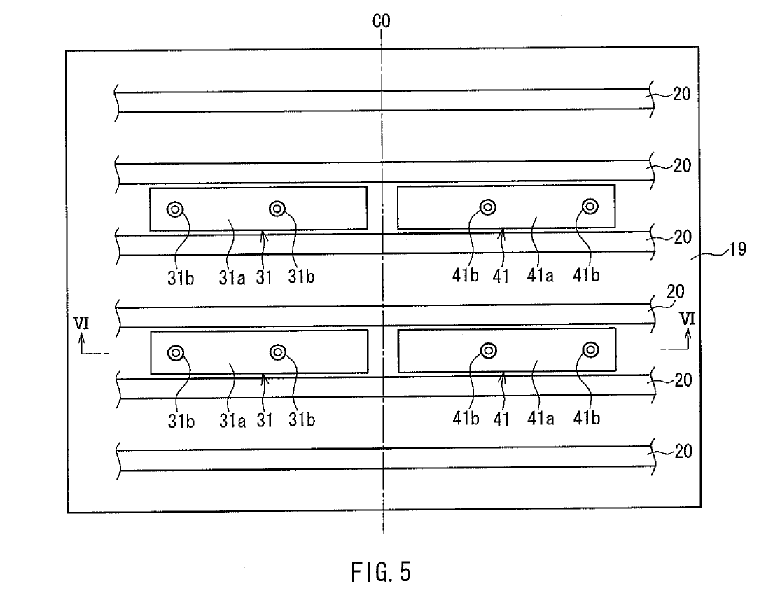

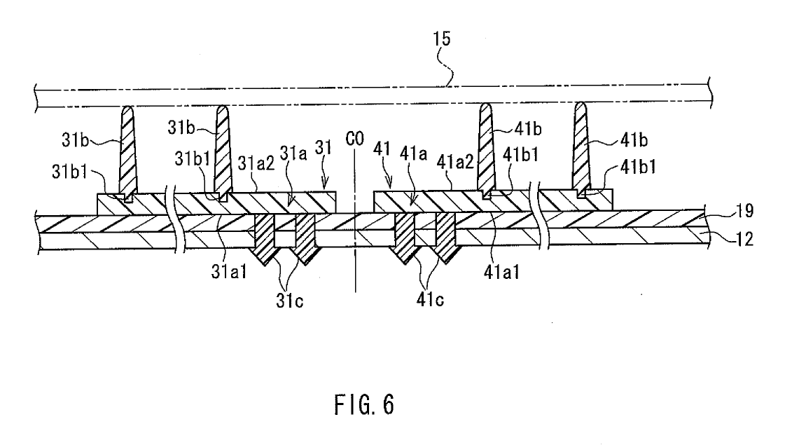

FIG. 5 is a plan view illustrating a configuration of main portions of an illuminating device according to a second embodiment of the present invention. FIG. 6 is a cross-sectional view taken along a line VI-VI shown in FIG. 5. In the figures, the present embodiment is different from the first embodiment mainly in that two diffusion plate supporters are provided along the longitudinal direction of cold cathode fluorescent tubes, and that the diffusion plate supporter provided on one end side in the longitudinal direction includes attachment portions on the other end side of a substrate in the longitudinal direction, while the diffusion plate supporter provided on the other end side in the longitudinal direction includes attachment portions on one end side of the substrate in the longitudinal direction. It should be noted that elements common to those in the first embodiment are denoted with the same reference numerals, and repeated descriptions thereof will be omitted.

Namely, as shown in FIG. 5, the illuminating device 3 of the present embodiment includes two diffusion plate supporters 31 and 41 in the chassis 12. These diffusion plate supporters 31 and 41 are located between the two adjacent cold cathode fluorescent tubes 20 along the longitudinal direction so as to be symmetrical with respect to a center line (shown by “C0” in FIG. 5) of the cold cathode fluorescent tubes 20 in the longitudinal direction. Specifically, the diffusion plate supporter 31 is provided on one end side in the longitudinal direction (left end side in FIG. 4), and the diffusion plate supporter 41 is provided on the other end side in the longitudinal direction (right end side in FIG. 4).

Further, as shown in FIG. 6, the diffusion plate supporter 31 includes a substrate 31a that is configured to be capable of being deformed elastically in response to changes in ambient temperature, and two attachment portions 31c and two support portions 31b located respectively on a lower surface 31a1 and an upper surface 31a2 of the substrate 31a opposed to each other, as in the first embodiment. Each of the support portions 31b includes a protrusion 31b1 and is configured to be attachable/detachable with respect to the substrate 31a.

Further, as shown in FIG. 6, in the diffusion plate supporter 31, the attachment portions 31c are located on the other end side of the substrate 31a in the longitudinal direction, and the support portions 31b are provided on one end side in the longitudinal direction. Further, a front end portion of each of the attachment portions 31c protrudes to the outside of the chassis 12 and is locked on an outer surface of the chassis 12, whereby the diffusion plate supporter 31 is assembled with the illuminating device 3.

Further, the diffusion plate supporter 41 includes a substrate 41a that is configured to be capable of being deformed elastically in response to changes in ambient temperature, and two attachment portions 41c and two support portions 41b located respectively on a lower surface 41a1 and an upper surface 41a2 of the substrate 41a opposed to each other, as in the first embodiment. Each of the support portions 41b includes a protrusion 41b1 and is configured to be attachable/detachable with respect to the substrate 41a.

Further, as shown in FIG. 6, in the diffusion plate supporter 41, the attachment portions 41c are located on one end side of the substrate 41a in the longitudinal direction, and the support portions 41b are provided on the other end side in the longitudinal direction. Further, a front end portion of each of the attachment portions 41c protrudes to the outside of the chassis 12 and is locked on the outer surface of the chassis 12, whereby the diffusion plate supporter 41 is assembled with the illuminating device 3.

With the above-described configuration, the illuminating device 3 of the present embodiment provides the same function and achieves the same effect as those in the first embodiment. Further, in the present embodiment, of the two diffusion plate supporters 31 and 41, the diffusion plate supporter 31 provided on the one end side in the longitudinal direction includes the attachment portions 31c on the other end side of the substrate 31a in the longitudinal direction, while the diffusion plate supporter 41 provided on the other end side in the longitudinal direction includes the attachment portions 41c on one end side of the substrate 41a in the longitudinal direction. Thus, in the present embodiment, the respective diffusion plate supporters 31 and 41 are located in the chassis 12 so that the elastic deformation of the substrates 31a and 41a is likely to occur. More specifically, in the substrates 31a and 41a, the elastic deformation is more likely to occur in response to changes in ambient temperature on one end side and the other end side than in a central portion in the longitudinal direction. Similarly, in the diffusion plate 15, the expansion/contraction is more likely to occur on one end side and the other end side than in the central portion. Thus, in the present embodiment, in the diffusion plate supporters 31 and 41, the generation of noise can be prevented more reliably.

It should be noted that in the present embodiment, the slide contact portion is provided only on one end side rather than at both ends of the substrate in the longitudinal direction, unlike the first embodiment. More specifically, in the diffusion plate supporter 31, the slide contact portion is provided only on one end side in the longitudinal direction (left end side in FIG. 5) so that the elastic deformation of the substrate 31a is likely to occur, and in the diffusion plate supporter 41, the slide contact portion is provided only on the other end side in the longitudinal direction (right end side in FIG. 5) so that the elastic deformation of the substrate 41a is likely to occur.

Besides the above description, three or more diffusion plate supporters may be provided along the longitudinal direction of the cold cathode fluorescent tubes (linear light sources) 20.

### Third Embodiment

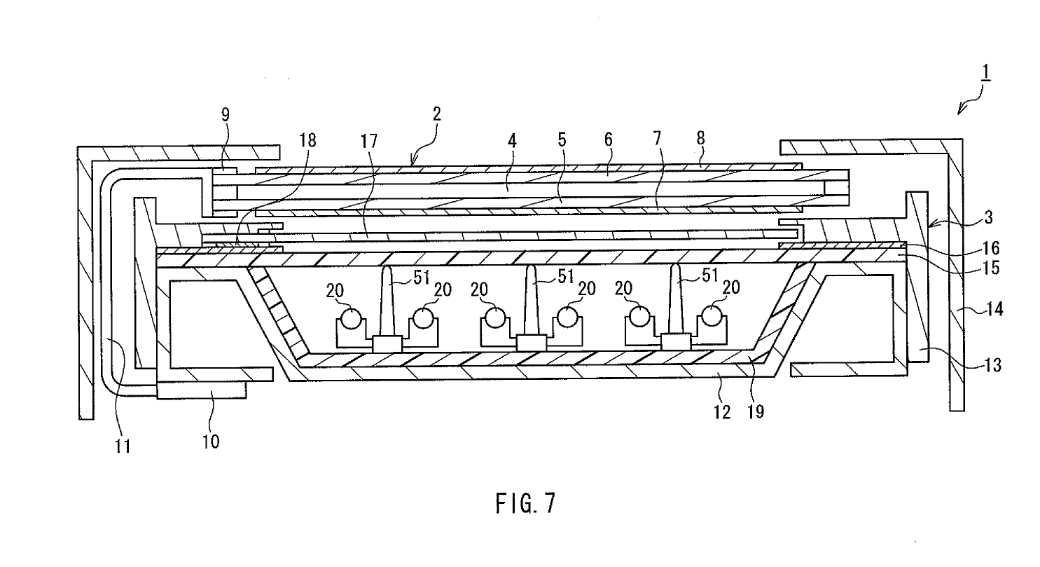

FIG. 7 is a schematic cross-sectional view illustrating an illuminating device and a liquid crystal display device according to a third embodiment of the present invention. In the figure, the present embodiment is different from the first embodiment mainly in that a holder for holding cold cathode fluorescent tubes is located on a substrate. It should be noted that elements common to those in the first embodiment are denoted with the same reference numerals, and repeated descriptions thereof will be omitted.

Namely, as shown in FIG. 7, in the illuminating device 3 of the present embodiment, the cold cathode fluorescent tubes 20 are held by diffusion plate supporters 51. Specifically, as shown in FIG. 7 by way of example, each of the three diffusion plate supporters 51 is located between the two adjacent cold cathode fluorescent tubes 20 so as to hold the two adjacent cold cathode fluorescent tubes 20 inside the chassis 12.

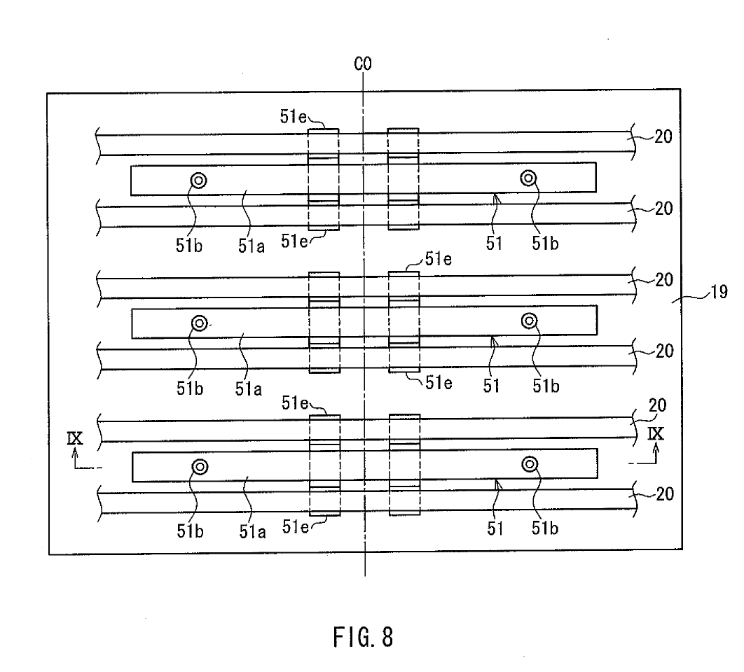

Here, the diffusion plate supporter 51 of the present embodiment will be described specifically also with reference to FIGS. 8 to 10.

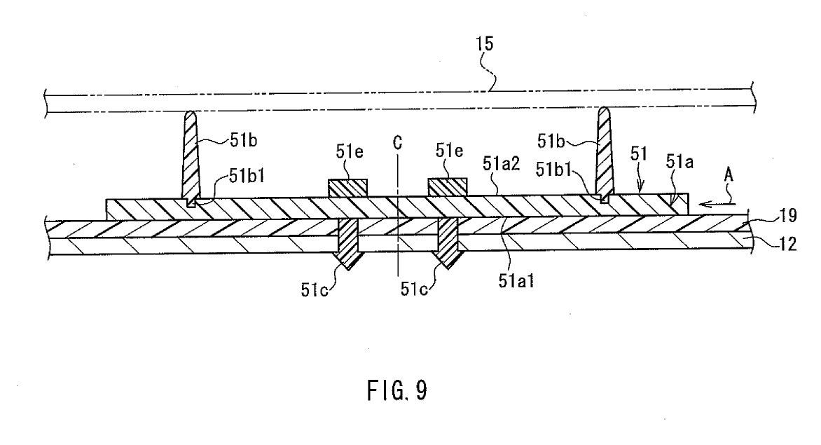

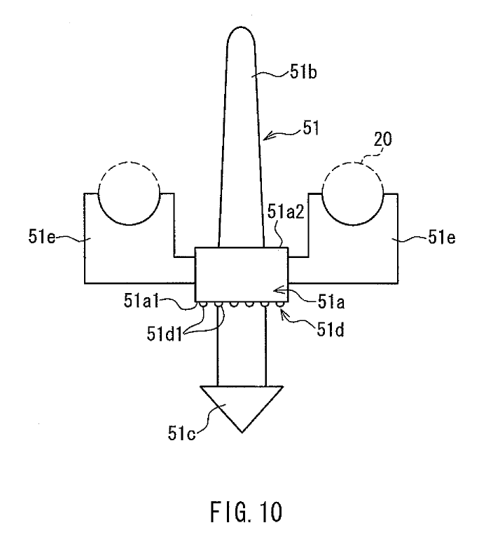

FIG. 8 is a plan view illustrating a configuration of main portions of the illuminating device shown in FIG. 7. FIG. 9 is a cross-sectional view taken along a line IX-IX shown in FIG. 8. FIG. 10 is a view illustrating a specific configuration of the diffusion plate supporter shown in FIG. 7 when viewed from an arrow A side in FIG. 9.

As shown in FIGS. 8 to 10, each of the diffusion plate supporters 51 includes a substrate 51a that is configured to be capable of being deformed elastically in response to changes in ambient temperature, and two attachment portions 51c and two support portions 51b provided respectively on a lower surface 51a1 and an upper surface 51a2 of the substrate 51a opposed to each other, as in the first embodiment. Each of the support portions 51b includes a protrusion 51b1 and is configured to be attachable/detachable with respect to the substrate 51a. Further, a front end portion of each of the attachment portions 51c protrudes to the outside of the chassis 12 and is locked on an outer surface of the chassis 12, whereby the diffusion plate supporter 51 is assembled with the illuminating device 3.

In the diffusion plate supporter 51, the two support portions 51b are located on the substrate 51a so as to be symmetrical with respect to a center position (shown by “C” in FIG. 9) in the longitudinal direction. Similarly, the two attachment portions 51c are located on the substrate 51a so as to be symmetrical with respect the center position in the longitudinal direction. Further, as shown in FIG. 9, in the diffusion plate supporter 51, the support portions 51b and the attachment portions 51c are located on the substrate 51a at positions different from each other in the longitudinal direction. Specifically, the two support portions 51b are attached to the substrate 51a on outer sides in the longitudinal direction relative to the attachment portions 51c.

Further, as shown in FIG. 10, in the diffusion plate supporter 51, a slide contact portion 51d that slides to contact the surface of the reflecting sheet 19 on the chassis 12 side is provided on the lower surface (one surface) 51a1 side of the substrate 51a on end sides of the substrate 51a (both end sides in the longitudinal direction). The slide contact portion 51d is composed of, for example, a plurality of semicircular protruding portions 51d1, so that the substrate 51a easily slides on the surface (surface on the chassis 12 side) of the reflecting sheet 19.

Further, as shown in FIG. 8, in the diffusion plate supporter 51, four holders 51e are provided so as to be attachable/detachable with respect to the substrate 51a. Two of the holders 51e are located on the substrate 51a so as to be opposed to each other at the same positions as the attachment portions 51c in the longitudinal direction. Each of the holders 51e is made of the same synthetic resin as that used for the substrate 21a and is configured so as to allow the cold cathode fluorescent tube 20 to be engaged with an approximately semicircular holding portion as shown in FIG. 10. Thus, by the holders 51e, the cold cathode fluorescent tubes 20 are held while being kept at predetermined distances from the diffusion plate 15 and the reflecting sheet 19.

With the above-described configuration, the illuminating device 3 of the present embodiment provides the same function and achieves the same effect as those in the first embodiment. Further, in the present embodiment, the holders 51e for holding the cold cathode fluorescent tubes (linear light sources) 20 are located on the substrate 51a of the diffusion plate supporter 51. Thus, it is possible to omit a holding member for holding the cold cathode fluorescent tubes 20, resulting in a reduced number of components of the illuminating device 3.

It should be noted that the above-described embodiments are illustrative and not limiting. The technical scope of the present invention is specified by the scope of the claims, and any modification falling in the scope of the configuration and equivalent described therein also fall in the technical scope of the present invention.

For example, although the above description explains the case where the present invention is applied to the transmission type liquid crystal display device, the illuminating device of the present invention is not limited thereto. The illuminating device of the present invention may be applied to various types of display devices each of which has a non-light-emitting type display portion for displaying information such as images and characters by utilizing light from a light source. Specifically, the illuminating device of the present invention can be applied suitably to a semi-transmission type liquid crystal display device or to a projection type display device in which a liquid crystal panel is used as a light bulb.

Further, besides the above description, the illuminating device of the present invention can be used suitably as a film viewer that irradiates light to a radiograph, a light box for irradiating light to a picture negative or the like to make it easy to recognize the negative visually, and a backlight of a light-emitting device that lights up a signboard, an advertisement set on a wall surface in a station, or the like.

Further, although the above description explains the case where the cold cathode fluorescent tube is used, the linear light source of the present invention is not limited thereto. Another discharge fluorescent tube such as a hot cathode fluorescent tube and a xenon fluorescent tube, or a non-straight-tube discharge fluorescent tube such as a U-shaped tube and a pseudo U-shaped tube may be used. Further, the linear light source may be realized by aligning a plurality of point light sources such as a light-emitting diode (LED).

Further, the above description explains the case where the two attachment portions and the two support portions are located on the substrate at positions different from each other. However, the number, position, and the like of the attachment portions and the support portions are not limited in anyway to those described above, as long as the diffusion plate supporter of the present invention includes the substrate that is configured to be capable of being deformed elastically in response to changes in ambient temperature, and the attachment portions and the support portions located on the substrate.

However, it is preferred that, as in the above-described embodiments, the two attachment portions are located on the substrate, because this can prevent the substrate from being rotated with respect to the chassis even when it is deformed elastically in response to changes in ambient temperature.

Further, it is preferred that, as in the above-described embodiments, the two or more support portions are located on the substrate, because this makes it possible to provide easily the illuminating device that only requires a small number of components and can be assembled easily.

Further, it is preferred that, as in the above-described embodiments, the attachment portions and the support portions are located on the substrate at positions different from each other, because this allows the support portions to be located in place so that the elastic deformation of the substrate is likely to occur, thereby preventing the generation of a friction sound between the support portions and the diffusion plate more reliably.

Further, in the third embodiment, the description explains the case where the two holders are located on the substrate so as to be opposed to each other at the same positions as the attachment portions. However, the shape, number, position, and the like of the holders in the diffusion plate supporter of the present invention are not limited in anyway to those described above.

However, it is preferred that, as in the third embodiments, the holders are located on the substrate in the vicinity of the attachment portions, because this allows the holders to be located in place so that the elastic deformation of the substrate is less likely to be inhibited, thereby preventing the generation of noise more reliably even when the holders are located on the substrate.

Further, although the above description explains the case where the support portions, the attachment portions, and the holders are provided so as to be attachable/detachable with respect to the substrate, the diffusion plate supporter of the present invention is not limited thereto. The substrate may be integrated with at least any of the support portions, the attachment portions, and the holders.

Further, besides the above description, the first to third embodiments may be combined suitably.

### INDUSTRIAL APPLICABILITY

The present invention is useful for an illuminating device that can prevent the generation of noise even when a diffusion plate expands/contracts, and a low-noise display device using the same.

1. An illuminating device provided with a linear light source, a chassis that houses the linear light source, and a diffusion plate that diffuses light from the linear light source, the illuminating device comprising
a diffusion plate supporter that is provided in the chassis to support the diffusion plate,
wherein the diffusion plate supporter comprises:
a substrate that is configured to be capable of being deformed elastically in response to changes in ambient temperature;
an attachment portion that is provided on one of opposed surface sides of the substrate and attaches the substrate to the chassis; and
a support portion that is located on the other of the opposed surface sides of the substrate so as to come into contact with the diffusion plate.

2. The illuminating device according to claim 1, wherein the substrate is made of a material having substantially the same coefficient of thermal expansion as the diffusion plate.

3. The illuminating device according to claim 1,
wherein the substrate is attached to the chassis along a longitudinal direction of the linear light source, and
the two attachment portions are located on the substrate along the longitudinal direction.

4. The illuminating device according to claim 1,
wherein the substrate is attached to the chassis along a longitudinal direction of the linear light source, and
the two or more support portions are located on the substrate along the longitudinal direction.

5. The illuminating device according to claim 1,
wherein the substrate is attached to the chassis along a longitudinal direction of the linear light source, and
the attachment portion and the support portion are located on the substrate at positions different from each other in the longitudinal direction.

6. The illuminating device according to claim 1,
wherein a plurality of the diffusion plate supporters are provided in the chassis along a longitudinal direction of the linear light source, and
among a plurality of the diffusion plate supporters, the diffusion plate supporter provided on one end side in the longitudinal direction includes the attachment portion on the other end side of the substrate in the longitudinal direction, while
the diffusion plate supporter provided on the other end side in the longitudinal direction includes the attachment portion on one end side of the substrate in the longitudinal direction.

7. The illuminating device according to claim 1, wherein a holder that holds the linear light source is located on the substrate.

8. The illuminating device according to claim 7, wherein the holder is located in the vicinity of the attachment portion on the substrate.

9. The illuminating device according to claim 1, wherein a slide contact portion that slides to contact a surface on the chassis side is provided on one of the surface sides of the substrate on an end side of the substrate.

10. A display device using the illuminating device according to claim 1.
